(19) United States
(12) Patent Application Publication
(10) Pub. No.: US 2020/0361111 A1
(43) Pub. Date: Nov. 19, 2020

(54) COMBINATION MITER AND TABLE SAW

(71) Applicant: Yogin Paramanand Suthar, Northridge, CA (US)

(72) Inventor: Yogin Paramanand Suthar, Northridge, CA (US)

(21) Appl. No.: 16/869,128

(22) Filed: May 7, 2020

Related U.S. Application Data
(60) Provisional application No. 62/847,251, filed on May 13, 2019.

(51) Int. Cl. B27B 5/16; B27B 5/20; B23D 59/00; B23D 47/02

(52) U.S. Cl. CPC B27B 5/165; B23D 47/025; B23D 59/007; B27B 5/206

(57) ABSTRACT

A combination miter and table saw includes a miter table connected to or formed integrally with a base assembly. A table saw table is disposed below the miter table in spaced relation to the miter table. A blade assembly includes a motorized cutting blade which is movable between a position above the miter table to a position at the miter table. The motorized cutting blade is also movable to a position through the miter table slot and to the table saw table. The blade assembly may be selectively locked into the position where the cutting blade is at the table saw table.

### RELATED APPLICATIONS

This application claims the benefit of U.S. Provisional Application No. 62/847,251, filed on May 13, 2019.

### BACKGROUND OF THE INVENTION

The present invention relates to power tools. More particularly, the invention relates to a multi-function power saw that performs the functions of a conventional miter saw and a conventional table saw. The invention allows a user to make cross cuts, bevel cuts, miter cuts, compound cuts, and rip cuts in target objects and does so in a single device of an efficient novel design.

In the construction and consumer home renovation industries, it is often necessary to cut wood and other materials. Sometimes it is necessary to shorten a long piece of wood by cutting it across its shorter dimension, known as chopping or cross cutting. A miter saw, including a simple miter saw, a compound miter saw, or a sliding compound miter saw, may be used to perform efficient cross cuts. These cuts may be simple cuts, beveled cuts, miter cuts, or compound miter cuts.

In miter saw operation, a motorized circular blade is pressed downward, via a pivoting arm assembly, onto a stationary piece of wood or target object which is placed on a table to cut the object. The blade is perpendicular to the length of the object to be cut. The size of the cut is limited by the diameter of the circular blade which is sufficient to cut across the shorter dimension of the object. The object, typically a piece of wood, is held stationary either by hand or some other mechanism against a back fence which serves to secure the object. When the circular blade of a miter saw is pressed downward on an object, the cutting edge of the circular blade passes minimally through a slot in the table on which the object rests. This allows the circular blade to completely cut through the width of the object. However, the blade is prevented from going any further.

Sometimes, it is necessary to cut a piece of wood or other object along the long dimension of the object, so as to reduce its width. This type of cut is typically known as a rip cut, or ripping. When one needs to cut along the long dimension of the object, which may be several feet, the miter saw cannot be used as the circular blade diameter is typically only several inches and the blade is fixed or able to move to a very limited degree. Additionally, the back fence and pivoting arm assembly prevent the target object from being pushed along the cutting direction of the blade. Instead, in this case, a table saw is used in which a circular powered rotating blade is projected upward through a slot in table—a large flat surface. The target object to be cut is then pushed over the table across the cutting blade. A side fence may be used to align the object to be cut along a straight path.

Thus, in the miter saw, the object to be cut is stationary and the cutting blade is pressed downward on it, typically cutting across its shorter dimension to create a simple cross cut, beveled cut, miter cut, or compound miter cut. In the table saw, however, the blade is stationary and the object is passed over it, so as to make long cuts along the length of an object.

The two types of cuts described are fundamental to many construction applications and therefore, both types of saws must be available. There are instances when a project will require both a miter saw as well as a table saw in order to perform all types of these cuts to the wood or other material. As an example, consider the installation of flooring planks—hardwood, laminate, etc. These planks are often 7″ wide by 48″ long or 9″ by 60″, among other specifications. During installation, these planks need to be shortened via cross cuts or decreased in width by rip cuts. However, having both a miter saw as well as a table saw available is expensive and logistically difficult.

There are dual function saws available on the market that perform the functions of both a miter saw and a table saw. The designs for such combination saws, however, are large and difficult to use. In these devices, the table necessary for rip cuts is placed atop the blade mechanism of the miter saw thereby creating a large, heavy apparatus which must be moved each time a cross cut is made.

Accordingly, there is a continuing need for a single device that can efficiently perform the functions of both a miter saw as well as a table saw in a small form factor that can be easily stored and transported from one job location to another, as needed. The present invention fulfills these needs and provides other related advantages.

### SUMMARY OF THE INVENTION

It is an objective of the present invention to provide a novel dual function saw to substantially perform the functions of a conventional miter saw for performing cross cuts and a conventional table saw for performing rip cuts.

It is yet another objective of the present invention to provide the dual function saw comprising an upper table and a lower table, wherein the upper table is used to perform a cross cut operation and the lower table is used to perform rip cut operation.

It is yet another objective of the present invention to provide the dual function saw, wherein the existing space underneath the table of a conventional miter saw is utilized to create a lower table on which an object to be cut can be passed to make a long rip cut.

It is yet another objective of the present invention to provide the dual function saw with a motorized blade assembly and a base assembly, wherein the motorized blade assembly is pivotally connected with the base assembly via a pivot connection and/or pivot arms.

It is yet another objective of the present invention to provide the dual function saw with a circular blade, wherein the circular blade can be pivotally moved upward and downward.

It is yet another objective of the present invention to provide the dual function saw with a circular blade, wherein the circular blade can be pivotally moved from an initial position towards the upper table using a first blade movement.

It is yet another objective of the present invention to provide the dual function saw with a circular blade, wherein the circular blade can be pivotally moved from the initial position towards the lower table using a second blade movement.

It is yet another objective of the present invention to provide the dual function saw with a circular blade, wherein the circular blade is allowed to pivotally move towards the upper table using the first blade movement and further pivotal movement of the circular blade is restricted.

It is yet an another objective of the present invention to provide the dual function saw with a circular blade, wherein the circular blade is allowed to pivotally move towards the lower table using the second blade movement until the blade edge sits in the kerf channel and further pivotal movement of the circular blade is restricted.

It is yet another objective of the present invention to provide the dual function saw with the circular blade, wherein the circular blade is secured in a clearance of a kerf channel in a fixed position to operate as rotatably fixed circular blade for performing the rip cut operation.

In accordance with these, and other objectives, the present invention is generally related to a combination miter and table saw in the form of a single device that can efficiently perform the functions of both a miter saw as well as a table saw in a small form factor. The combination or dual-function saw generally comprises a base assembly. A miter table is connected to or formed integrally with a base assembly. A slot is formed through the miter table. A table saw table is disposed below the miter table, in spaced relation to the miter table. A blade assembly, including a motorized cutting blade is movable between a position above the miter table, to a position at the miter table slot, and to a position through the miter table slot and to the table saw table.

The blade assembly may include a handle and an electric motor for rotating the cutting blade. The cutting blade cuts material placed on the miter table as the blade assembly is moved to the position at the miter table. The cutting blade cuts material placed on the table saw table when the cutting blade is moved through the miter table slot and at the table saw, and as material is urged to the cutting blade. Typically, the blade assembly is selectively locked into the position where the cutting blade is at the table saw table.

A pivot mechanism may be coupled to the blade assembly for selectively moving the blade assembly between the positions above the miter table, at the miter table, and/or the table saw table. A pivot arm may extend between the blade assembly and the pivot mechanism. The pivot mechanism may be attached to the miter table or the base assembly. The miter table may be rotatable with respect to the base assembly. The cutting blade may be pivotable with respect to a front-back vertical axis so as to create bevel cuts in material placed on the miter table or the table saw table.

The table saw table may be detachably connected to the base assembly. An adjustable material guide may be connected to the table saw table.

The distance between the miter table and the table saw table may be selectively variable and adjustable to accommodate material of varying thicknesses.

A width of the base assembly may accommodate material of different sizes on the table saw table.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a front perspective view of the combination saw of embodying the present invention, with the blade assembly thereof in an uppermost position;

FIG. 2 is a front perspective view of the combination saw, illustrating the blade assembly moved into a position at a miter table of the saw, so as to cut an object placed thereon;

FIG. 3 is a front perspective view of a combination saw embodying the present invention, illustrating pivoting of the cutting blade with respect to a front-back vertical axis so as to create bevel cuts, in accordance with the present invention;

FIG. 4 is a partial front perspective view illustrating the blade moved into a lower position at a table saw table, with an object to be cut moved towards the cutting blade;

FIG. 5 is a rear perspective view illustrating the combination saw of the present invention with the cutting blade in a lower position and cutting material placed on the table saw table;

FIG. 6 is a perspective view of a pivot mechanism and selectively adjustable locking mechanism of the present invention in an unlocked state;

FIG. 7 is a perspective view similar to FIG. 6, illustrating the pivoting mechanism in a locked position, in accordance with the present invention;

FIG. 8 is a bottom perspective view of the combination saw without the table saw table, but illustrating attachment points of a base assembly, in accordance with the present invention; and

FIG. 9 is a top perspective view of a table saw table used in accordance with the present invention, and having adjustable connectors.

### DETAILED DESCRIPTION OF THE PREFERRED EMBODIMENTS

As shown in the accompanying drawings, for purposes of illustration, the present invention relates to a power cutting tool, more particularly, a combination miter and table saw, generally referred to by the reference number 10. The combination saw 10 is designed and configured so as to perform miter cuts, such as cross cuts, bevel cuts, and combination cuts, as in a traditional miter saw, as well as rip cuts like those made by a traditional table saw. The present invention eliminates the need to use, transfer and store two different power tools to perform these types of cuts, while presenting a single device 10 which is approximately the size of a traditional miter saw and which can be easily manually transported to a jobsite and which performs all of the aforementioned cuts, which otherwise would require both a miter saw as well as a table saw.

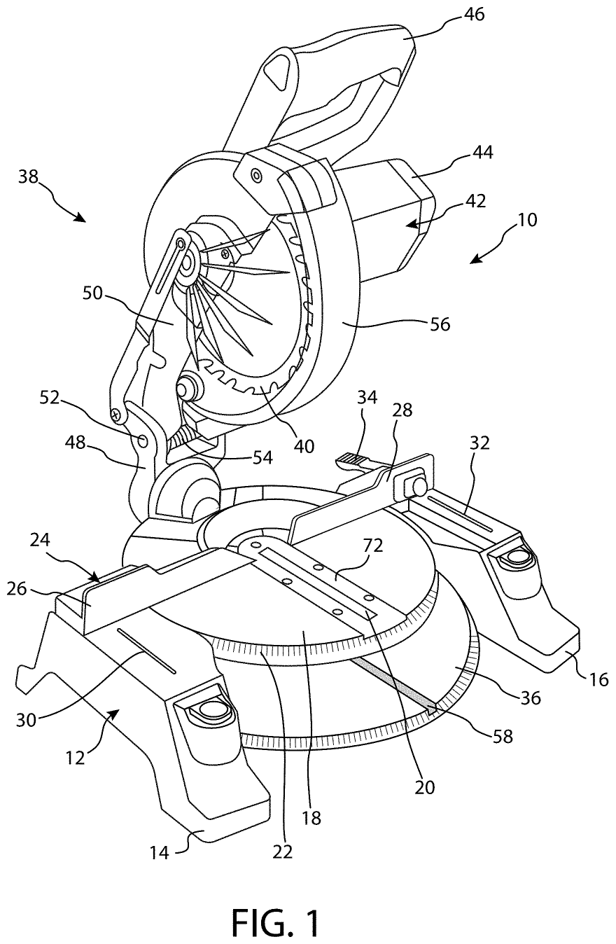

The combination miter and table saw 10, as illustrated in FIG. 1, comprises a base assembly 12 which can be placed upon a support surface for supporting the combination saw 10. The base assembly 12 typically includes spaced apart feet 14 and 16, or other structure which is sufficiently spaced apart so as to support the saw 10 and allow rip cuts in accordance with the present invention, as more fully described herein.

A miter table 18 is connected to, or may be formed integrally, with the base assembly 12. Preferably, the miter table 18 is rotatably connected to the base assembly 12 so that cross cuts of different angles may be formed in the material placed upon the miter table 18. A slot 20 is formed through the upper miter table 18 to allow a cutting blade to extend therein and thus completely pass through an object to be cut during the cutting operation. The miter table 18 may also include a miter scale 22 used when rotating the miter table 18 to assist in making angled cuts in a precise manner.

A fence assembly 24 is associated with or connected to the base assembly 12 which includes a first or left fence 26 and a second or right fence 28 which are used to secure an object to be cut during miter cuts. The left and right fences 26 and 28, or the fence assembly 24, may be adjustable, such as riding within tracks 30 and 32, so that the fences 26 and/or 28 may be slid and extended or retracted as desired. A locking mechanism, such as the illustrated thumb lever 34 can be used to selectively lock the fence assembly 24 in place within tracks 30 and 32. In this manner, an object may be supported or stabilized in a desired position on the miter table 18. However, the fences 26 and 28 may not be adjustable, but rather just the miter table 18 rotatable and lockable into place.

In accordance with the present invention, a second lower table, comprising a table saw table 36 is disposed below the miter saw table 18 in spaced relation thereto. The table saw table 36 may be integrally formed with the base assembly 12, operably connected to the base assembly 12, or even detachably connected to the base assembly 12, as will be more fully described herein. The upper miter table 18 and the lower table saw table 36 lie generally parallel to one another and are sufficiently spaced apart from one another that objects to be cut via a rip cut can pass therebetween. The invention contemplates, as will be more fully discussed herein, adjusting the space between the upper and lower tables 18 and 36.

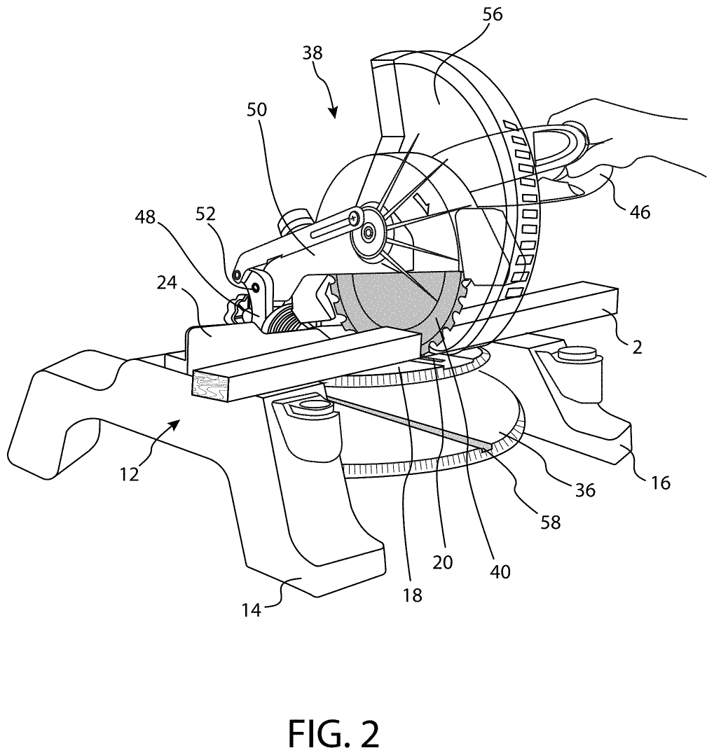

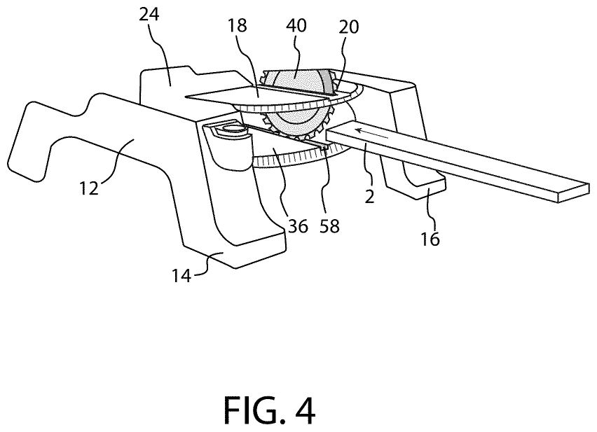

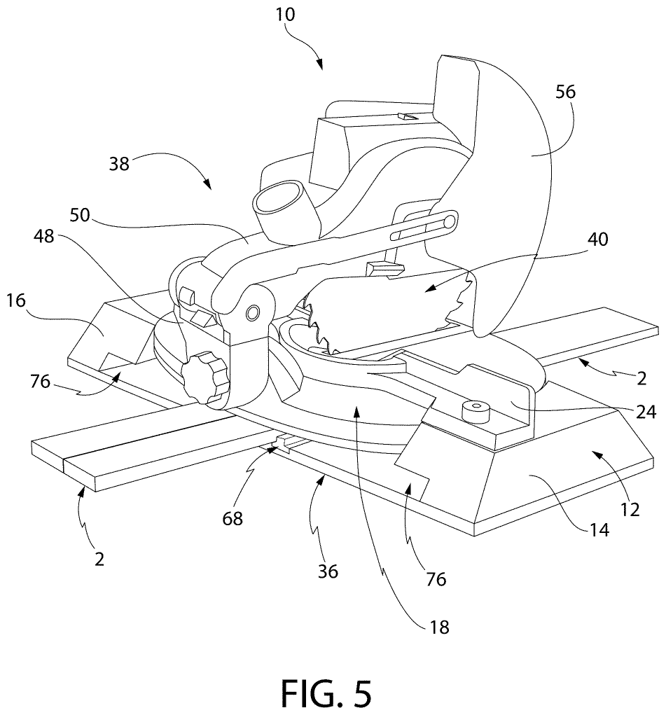

A blade assembly 38, including a motorized cutting blade 40, is movable between an at-rest position above the miter table 18, as illustrated in FIG. 1, to a position at the miter table 18, as illustrated in FIG. 2, and to a position through the miter table slot 20 and to the table saw table 36, as illustrated in FIGS. 4 and 5. In this manner, the combination saw 10 can perform miter cuts, including cross cuts, bevel cuts, or combination cuts in wood or other objects placed on the miter table 18, as well as performing traditional table saw cuts, such as rip cuts, in wood or other material placed upon the table saw table 36 and urged into the cutting blade 40, as illustrated in FIGS. 4 and 5. As will be more fully described herein, the blade assembly 38 is selectively locked into a position where the cutting blade 40 is at the table saw table for performing such rip cuts and the like.

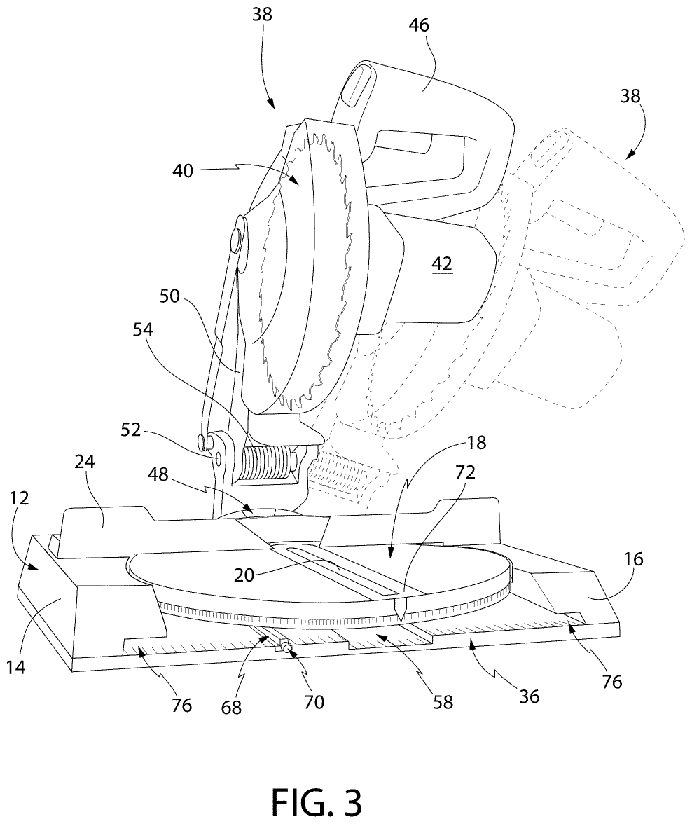

The blade assembly 38 may be operably connected to the base assembly 12, but more typically is connected to the miter table 18 so that it can be rotated clockwise or counterclockwise within the base assembly 12. Miter table 18 is rotatable, along with attached blade assembly 38, within base assembly 12 to perform miter cuts at various angles. As illustrated in FIG. 3, the blade assembly 38 is also selectively pivotable with respect to a front to back vertical axis, so as to create beveled or angled cuts in the material or even combination cuts.

The blade assembly 38 generally comprises an electric motor 42 operably connected to the cutting blade 40. The motor 42 is typically encased within a housing 44. A handle 46, which may be connected to the motor assembly 42, enables a user to pivotally move the motorized blade assembly 38 upwardly and downwardly, and to carry the combination saw 10 from one place to another.

Typically, as illustrated, the blade assembly 38 is pivotally connected to the base assembly 12 or miter table 18. This allows the selective upward and downward movement of the motorized blade assembly 38, and cutting blade 40. This may be accomplished, for example, by means of a pivot or rotation mechanism 48 which is coupled to the base assembly or miter table 18 and which is coupled to the blade assembly 38 by one or more pivot arms 50. The pivot connection 52 between pivot arm 50 and pivot or rotating mechanism 48 enables the blade assembly 38, and thus the cutting blade 40 to be selectively pivoted or raised and lowered between its uppermost position to its lowermost position at the table saw table 36.

The blade assembly 38, and thus the motorized cutting blade 40 is movable from an initial position above the miter table 18, as illustrated in FIG. 1 to lower positions. Typically, the blade assembly 38 is biased upwardly into this initial, at-rest position, such as by means of a spring 54 or the like. As illustrated in FIG. 2, the blade assembly, and thus cutting blade 40, can be selectively moved downwardly into a second position at the miter table 18 and into slot 20 of the miter table 18, so as to perform miter cuts on wood or other objects 2 placed upon the miter table 18. Once again, as illustrated in FIG. 3, the blade assembly 38, and thus the cutting blade 40, may be pivoted or rotated from its typical vertical axis to another position, using the pivot/rotation mechanism 48, so as to create angled or beveled cuts or the like in the material 2. Traditionally, miter saws are only able to have the cutting blade 40, and blade assembly 38, lowered to the position at the miter table 18, so as to slightly extend into or through the slot 20 formed in the miter table 18, and either form the cross cuts, miter cuts, bevel cuts, or combination cuts on material placed upon the miter table 18 so as to create the miter cut, typically in the shorter dimension or width of the object 2, as illustrated in FIG. 2.

As illustrated in the figures, the blade assembly 38 may include a retractable safety blade guard 56 which covers the cutting blade 40, but which is retractable, as illustrated in FIGS. 2 and 5, when the cutting blade 40 is cutting an object 2. The safety guard 56 is typically biased into the closed position covering the cutting blade 40, but as it contacts the miter table 18 remains in position as the cutting blade 40 continues to be lowered.

The blade assembly 38, and cutting blade 40, may be further moved in a first movement from its first, at-rest position, as illustrated in FIG. 1, to its second cutting position at the miter table 18, and in a second movement through the miter table slot 20 to a third position at the table saw table 36, where the cutting blade 40 in this position and the table saw table 36 cooperatively act as a table saw in order to perform table saw cuts, such as rip cuts to wood or other objects 2, typically along the longer dimension thereof, as illustrated in FIGS. 4 and 5. This feature and ability is not possible with traditional miter saws.

However, in the present invention, the hinge or pivot mechanism 48 connecting the pivot arm 50 to the base assembly 12 is configured and designed so that the cutting blade 40 can be passed through the miter table slot 20 so that a substantial portion of the circular cutting blade 40 is below the miter table 18 and positioned at the table saw table 36. Preferably, the table saw table 36 includes an open-faced channel or kerf slot 58 formed therein and generally aligned with the miter table slot 20 such that the cutting blade 40 can extend partially therein so that the object 2 may be cut completely. It will be understood that the kerf channel 58 provides clearance for the edge of the cutting blade 40 to spin in a fixed rotatable position for performing the rip cut operation.

The circular cutting blade 40 is preferably locked securely in the position at the table saw table 36 to enable the user to use both hands in holding and urging the material or object 2 to be cut into the rotating cutting blade 40, similar to how a user would utilize both hands when utilizing a traditional table saw. With the circular cutting blade 40 secured into position to operate as rotatably fixed for performing the rip cut operation, the user need not hold down the cutting blade assembly 30, but instead can utilize both hands to perform the rip cut or other cut on the piece of material or object placed on the table saw table 36. The upward and downward movement of the blade assembly 38 and cutting blade 40 are restricted by use of a locking system so that the cutting blade 40 is secured in rotatably fixed position at the table saw table 36, so as to extend somewhat into the kerf channel 58. Any locking means can be utilized to rotatably secure the blade assembly 38, and the cutting blade 40, in the fixed position for performing the rip cut.

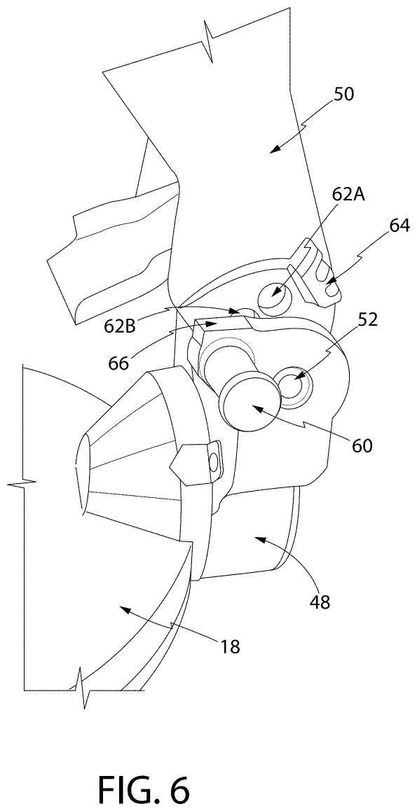

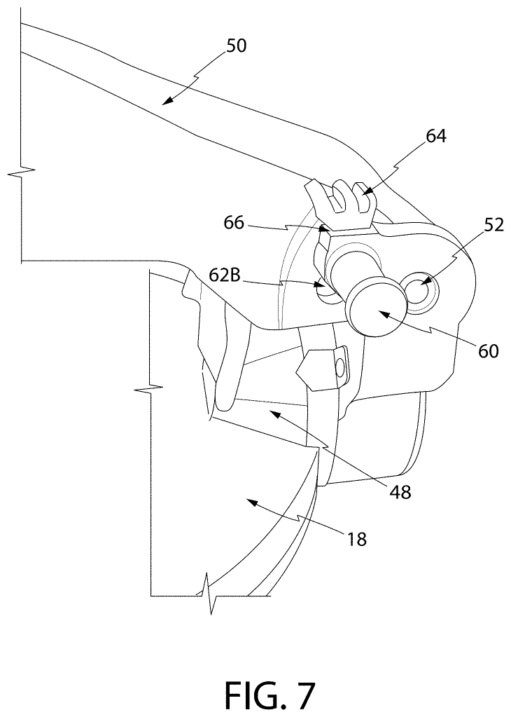

With reference now to FIGS. 6 and 7, an exemplary mechanism to secure and lock the pivot arm 50 and blade assembly 38 in place during table saw operation is shown. When operated as a table saw, the cutting blade 40 must be plunged below the top miter table 18 and into the kerf channel 58 of the lower table saw table 36. Here, the cutting blade 40 position must be firmly locked to prevent the blade 40 from further moving downward and causing damage to the blade and/or lower table saw table 36. Moreover, the blade 40 must be held in place to resist the upward bias of spring 54 during operation.

With continuing reference to FIGS. 6 and 7, an exemplary locking mechanism is shown. This is associated with the pivot and rotation mechanism 48 and the pivot arm 50. A pin 60 is selectively insertable into or disengaged with one or more apertures 62 associated with the pivot arm 50. When the pin 60 is disengaged, the pivot arm 50 is free to move along the arc of its movement. However, when the blade assembly 38 is moved downwardly such that the cutting blade 40 is in position at the table saw table 36, pin 60 is inserted into aperture 62 so as to lock the arm 50 in place. The engagement and disengagement of pin 60 can be performed manually by gripping and pulling or pushing pin 60 into and out of the aligned aperture 62. FIG. 6 illustrates the pin 60 in the disengaged position, such that the pivot arm 50 can freely be pivoted and moved along its arc of movement. FIG. 7, on the other hand, illustrates the pin 60 pushed into and engaged with an aperture 62, so as to lock the pivot arm 50 into place, and the cutting blade 40 at the table saw table 36. Depending on the position of table saw table 36, the pin 60 may be inserted into aperture 62A or 62B, when the position of the table saw table 36 is adjustable, as described herein.

To prevent the cutting blade 40 from being lowered excessively, such as into contact with the table saw table 36, a stop mechanism may be used to limit the downward travel of the blade assembly 38. With continuing reference to FIGS. 6 and 7, a stopper 64, movable as the pivot arm 50 is moved, is engageable with a platform or abutment 66 of the pivot mechanism 48, such as a portion of a plate which holds the pin 60, as illustrated. As the cutting blade 40 is moved into the kerf channel 58 of the table saw table 36, stopper 64 will come into contact with the platform 66 or other corresponding structure to prevent further downward movement of the pivot arm 50, and thus the cutting blade 40.

With reference again to FIG. 6, when the locking pin 60 is disengaged, as illustrated in FIG. 6, the blade assembly 38, and cutting blade 40 are capable of being freely moved between the uppermost at-rest position, as illustrated in FIG. 1, to a cutting position at the miter table 18, as illustrated in FIG. 2. The blade assembly 38 and cutting blade 40 can also be moved through the miter table slot 20 towards the table saw table 36, until an edge of the cutting blade 40 resides within the kerf channel 58, at which point stopper 64 will engage platform 66 and prevent further movement, at which point the locking pin 60 can be moved into engagement with aperture 62, as illustrated in FIG. 7, to lock the cutting blade in place in the table saw position. If locking pin 60 is not engaged, then the blade assembly 38 will be biased upwardly by spring 54, and the user can freely move the blade assembly 38 along the arc of its travel.

With reference now to FIGS. 3 and 5, it can be seen that the saw 10 of the present invention is designed and configured such that the pivoting and rotating mechanism 48, miter table 18 and base assembly 12 are positioned such that clearance is created between the top miter table 18 and the lower table saw table 36 to allow an object 2 to be cut and passed through completely. Particularly, the pivoting assembly mechanism 48 is positioned higher on the rear of the miter table 18 or base assembly 12 so that it does not create a blockage of the rear clearance, as would be the case in conventional miter saws.

With continuing reference to FIGS. 3 and 5, a guide rail 68 may be slidably connected to the table saw table 36 to guide the object 2 in a straight path through the cutting blade 40. Depending upon the width or dimension of the object to be cut, the guide rail 68 may be moved, and locked in place with lock 70, which may comprise a thumb screw which is tightened to secure the guide rail 68 in a specific position, as desired. Other locking means, such as a locking lever or the like may be used to lock the guide rail 68 in the desired location along the table saw table 36.

With reference now to FIGS. 2 and 3, the kerf channel 58 formed in the table saw table 36, as mentioned above, enables a lower edge of the cutting blade 40 to enter in thereto and enable the cutting blade 40 to completely cut an object placed on the table saw table 36 and passed through the rotating cutting blade 40. In FIG. 2, the kerf channel 58 is shown being fairly narrow. However, in FIG. 3, the kerf channel 58 is much wider, which enables the cutting blade 40 to be positioned at a different angle, such as when the blade assembly 38 is pivoted or rotated away from vertical, as illustrated in FIG. 3, such that angled or beveled cuts may be formed in the material which is rip cut at the lower table saw table 36. The increased width of the kerf channel 58 enables the blade to move from a generally vertical position to an angled position either left or right of vertical and still be within kerf channel 58 to create the desired cut. The miter table slot 20 will need to be sufficiently wide so as to allow the non-vertically angled cutting blade 40 to extend therethrough. The slot 20 may be formed with the appropriate dimension, or alternatively, a removable insert 72 may be positioned at the miter table slot 20 which can provide a larger width for the angled cutting blade 40 to extend therethrough and into kerf channel 58 at a non-vertical angle, when desired. It is desirable to be able to view the edge of the cutting blade 40 and where it makes contact with target object 2 before initiating a cut. This allows the operator to precisely position target object 2 for the intended location of the cut. The slot 20 may allow a sufficient view. However, the present invention envisions further accommodation by using a transparent material such as clear plastic for insert 72 that will provide a greater range for viewing the cutting blade 40 in its relation to the target object 2.

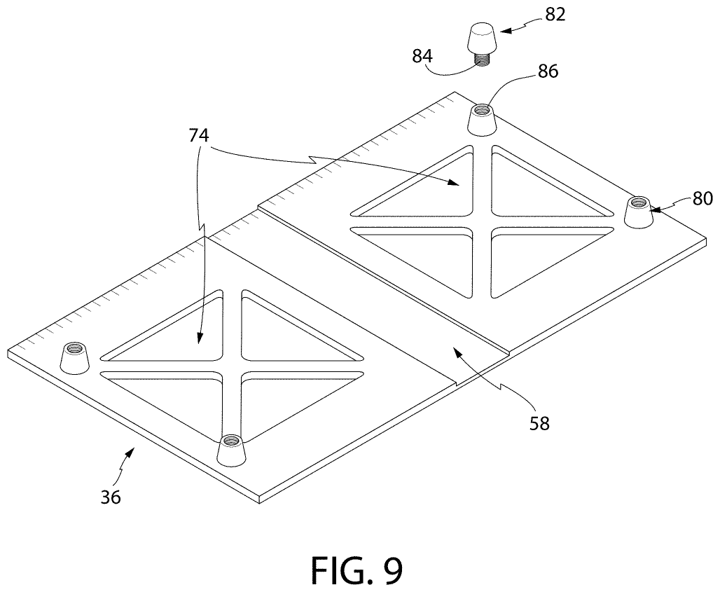

As shown in FIGS. 1-5, the lower table saw table 36 may assume different shapes, which may accommodate weight and strength requirements. In FIGS. 1-3, it is depicted with a circular edge that substantially matches that of the upper miter table 18. However, in the remaining figures, the table saw table 36 is depicted with a straight front edge that may be flush with the front edges of the two base feet 14 and 16. The table saw table 36 may be permanently connected to the base assembly 12, or detachably connected thereto. This may be desirable, for example, to remove the table saw table 36 and reduce the overall weight of the combination saw 10 to facilitate its manual transport. Alternatively, or additionally, as illustrated in FIG. 9, cutouts 74 may be formed in the lower table saw table 36 to reduce its weight.

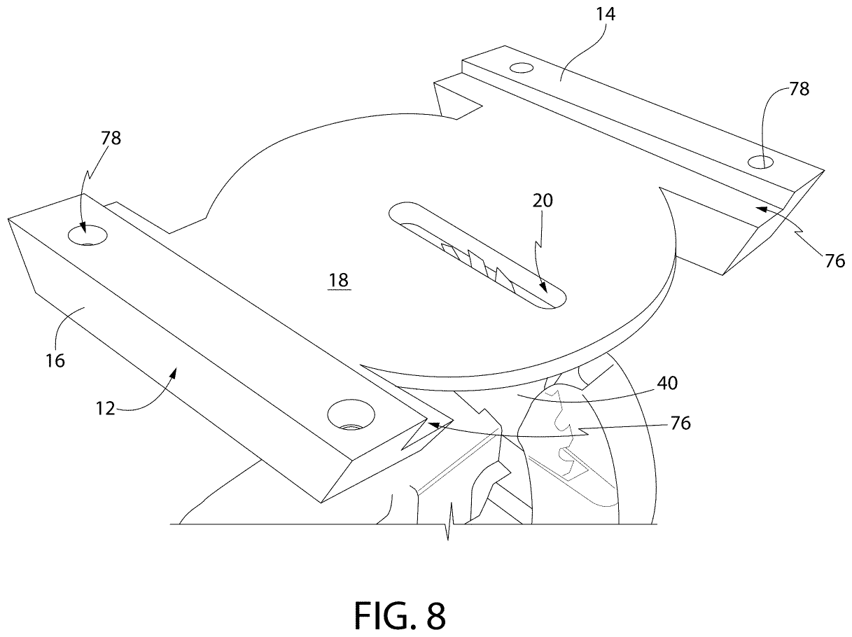

The table saw table 36 is preferably as wide, or has the greatest dimension, as possible, so as to accommodate pieces of wood or other objects of varying diameter and sizes. The width of the base assembly 12 may accommodate material of different sizes on the table saw table 36. To increase the allowable object width, clearance channels 76 may be created in the base assembly 12, such as in the base feet 14 and 16, as illustrated. The inside edges, from front to back, as illustrated in FIG. 8, are cut away from the bottom of the base feet, which may match a height of the lower surface of the miter table 18. It is also contemplated by the present invention that the base assembly 12 be of selectively variable and adjustable width to accommodate table saw tables 36 of varying width or objects of varying size and width. This could be accomplished, for example, by selectively adjusting the width between feet 14 and 16. This could be implemented instead of, or in addition to, the use of the undercuts or channels 76 formed in the base assembly or base feet 14 and 16.

It may be desirable to cut thicker objects than the default positioning of the lower table saw table 36 with respect to the upper miter table 18 allows. This would require a greater space in between these tables 18 and 36. However, it also may be desirable to have a more compact device when working with thin objects, such as flooring panels or the like. The present invention allows the distance between the miter table 18 and the table saw table 36 to be selectively variable. This can be accomplished, for example, by enabling the lower table saw table 36 to be detachably connected to the base assembly 12 in such a manner so as to increase or decrease the space or clearance between the miter table 18 and the table saw table 36. It is contemplated by the present invention that the table saw table 36 could be detachably connected to the base assembly 12 in a number of ways to accomplish this variable clearance.

With reference to FIGS. 8 and 9, a method for adjusting the clearance is illustrated. Apertures 78 are formed in the base assembly 12, such as through the bottom surface of feet 14 and 16. Male pins 80 are attachable to or extend upwardly from the table saw table 36 and are insertable into apertures 78. The connection could be by frictional fit, magnetic fit, or male-female mating connection. Pins 80 may be comprised of a magnetic material and legs 14 and 16 comprised of a ferromagnetic metal, or having magnetic inserts therein to form a magnetic connection. Any other known connection means is also contemplated by the invention. The table saw table 36 could be placed on a surface, and the saw 10 placed thereover until pins 80 engage apertures 78, causing a mechanical and/or magnetic interlock so as to attach and position the table saw table 36 to the base assembly 12. As illustrated, the pins 80 may have an outer surface configuration, such as being slightly conical in shape, which would substantially match an inner surface configuration of apertures 78 to form a mechanical connection. Alternatively, or additionally, the male 80 and female 78 connectors may contain strong magnets to facilitate alignment and establish a secure connection.

To increase the distance between the upper miter table 18 and the lower table saw table 36, using the mechanisms illustrated in FIGS. 8 and 9, extension pins 82 may be used. The extension pins 82 could have a threaded post 84 which is threadedly received by interior threads 86 of the male pin 80 so as to be screwed therein. The extender pin 82 has an outer surface configuration substantially matching that of the male pin 80 so as to be mated with the female connector aperture 78 on the assembly body 12 of the saw 10. The extender pins 82 may be of varying lengths to allow varying clearance distances between the tables 18 and 36, and/or the post 84 may be fully threaded into pins 80, or only partially threaded into pins 80, causing adjustability in height and distance between the tables 18 and 36. Other methods of adjusting the clearance space between the miter table 18 and the table saw table 36 are also contemplated by the present invention, such as a series of open-faced channels formed in the base assembly 12, such as the opposing surfaces of feet 14 and 16, enabling the table saw table 36 to be selectively slid into corresponding slots, and adjusting the clearance space between the table saw table 36 and the bottom surface of the miter table 18. Thus, objects of varying thickness could be rip cut by the cutting blade 40, when positioned in the table saw position. Alternatively, male pins 80 may be screwable into table saw table 36 and male pins 80 themselves may be of various sizes to adjust the distance between table saw table 36 and the bottom surface of miter table 18.

Although several embodiments have been described in detail for purposes of illustration, various modifications may be made without departing from the scope and spirit of the invention. Accordingly, the invention is not to be limited, except as by the appended claims.

What is claimed is:

1. A combination miter and table saw, comprising:
a base assembly;
a miter table connected to or formed integrally with the base assembly;
a slot formed through the miter table;
a table saw table disposed below the miter table in spaced relation to the miter table; and
a blade assembly, including a motorized cutting blade movable between a position above the miter table, to a position at the miter table slot, and to a position through the miter table slot and at the table saw table.

2. The combination saw of claim 1, wherein the blade assembly is selectively locked into the position where the cutting blade is at the table saw table.

3. The combination saw of claim 2, wherein the cutting blade cuts material placed on the table saw table as the material is urged to the cutting blade when the cutting blade is in the locked position at the table saw table.

4. The combination saw of claim 1, wherein the cutting blade cuts material placed on the miter table as the blade assembly is moved to the position at the miter table.

5. The combination saw of claim 1, wherein the blade assembly further comprises a handle and an electric motor for rotating the cutting blade.

6. The combination saw of claim 1, including a pivot mechanism coupled to the blade assembly for selectively moving the blade assembly between the positions above and at the miter table and/or the table saw table.

7. The combination saw of claim 6, including a pivot arm extending between the blade assembly and the pivot mechanism.

8. The combination saw of claim 6, wherein the pivot mechanism is attached to the miter table or the base assembly.

9. The combination saw of claim 1, wherein the miter table is rotatable with respect to the base assembly.

10. The combination saw of claim 1, wherein the cutting blade is pivotable with respect to a vertical axis so as to create bevel cuts in material placed on the miter table or the table saw table.

11. The combination saw of claim 1, wherein the table saw table is detachably connected to the base assembly.

12. The combination saw of claim 1, including an adjustable material guide connected to the table saw table.

13. The combination saw of claim 1, wherein the distance between the miter table and the table saw table is selectively variable.

14. The combination saw of claim 1, wherein a width of the base assembly accommodates material of different sizes on the table saw table.

15. A combination miter and table saw, comprising:
a base assembly;
a miter table connected to or formed integrally with the base assembly;
a slot formed through the miter table;
a table saw table disposed below the miter table in spaced relation to the miter table;
a pivot mechanism attached to the base assembly or the miter table;
a blade assembly including a handle, a motor and a cutting blade operably connected to the motor;
a pivot arm extending between the pivot mechanism and the blade assembly;
wherein the cutting blade is movable between a position above the miter table to a position at the miter table to cut material placed on the miter table, and to a position through the miter table slot and to the table saw table to cut material placed on the table saw table and urged to the cutting blade;
wherein the blade assembly is selectively locked into the position where the cutting blade is positioned at the table saw table.

16. The combination saw of claim 15, wherein the miter table and blade assembly are rotatable with respect to the base assembly.

17. The combination saw of claim 15, wherein the cutting blade is pivotable with respect to a vertical axis so as to create bevel cuts in material placed on the miter table or the table saw table.

18. The combination saw of claim 15, wherein the table saw table is detachably connected to the base assembly.

19. The combination saw of claim 15, including an adjustable material guide connected to the table saw table.

20. The combination saw of claim 15, wherein the distance between the miter table and the table saw table is selectively variable.

21. The combination saw of claim 15, wherein a width of the base assembly accommodates material of different sizes on the table saw table.
